(19) United States
(12) Patent Application Publication
(10) Pub. No.: US 2018/0284925 A1
(43) Pub. Date: Oct. 4, 2018

(54) TOUCH INPUT DEVICE AND METHOD FOR MEASURING CAPACITANCE OF THE SAME

(71) Applicant: HiDeep Inc., Gyeonggi-do (KR)

(72) Inventor: Young Ho Cho, Gyeonggi-do (KR)

(21) Appl. No.: 15/939,891

(22) Filed: Mar. 29, 2018

(30) Foreign Application Priority Data
Mar. 29, 2017 (KR) 1020170040043

(51) Int. Cl. G06F 3/044; G06F 3/041

(52) U.S. Cl. CPC G06F 3/044; G06F 2203/04101; G06F 3/0414

(57) ABSTRACT

A touch input device and a method for measuring a capacitance of the touch input device may be provided. The touch input device includes: a display panel; a pressure sensor which is disposed under the display panel; a reference potential layer which is disposed apart from the pressure sensor; and a controller which receives an output voltage from the pressure sensor and calculates a first capacitance value, and calculates a second capacitance value by removing a parasitic capacitance value from the first capacitance value. The controller receives the output voltage from the pressure sensor in a state where the reference potential layer is floating, and calculates the parasitic capacitance value.

### CROSS REFERENCE TO RELATED APPLICATIONS

Priority is claimed under 35 U.S.C. § 119 to Korean Patent Application No. 10-2017-0040043, filed Mar. 29, 2017, the disclosure of which is incorporated herein by reference in its entirety.

### BACKGROUND

### Field

The present disclosure relates to a touch input device and a method for measuring a capacitance of the touch input device, and more particularly to a touch input device capable of accurately detecting a touch pressure magnitude transmitted through a pressure sensor within the capacitive touch input device by removing a parasitic capacitance value caused by external factors instead of a capacitance value to be detected between a reference potential layer and the pressure sensor from the measured capacitance value.

### Description of the Related Art

Various kinds of input devices are being used to operate a computing system. For example, the input device includes a button, key, joystick and touch screen. Since the touch screen is easy and simple to operate, the touch screen is increasingly being used to operate the computing system.

The touch screen including a transparent panel with a touch-sensitive surface and a touch sensor as a touch input means can constitute a touch surface of a touch input device. The touch sensor is attached to the front side of a display screen, so that the touch-sensitive surface may cover the visible side of the display screen. A user is allowed to operate the computing system by simply touching the screen by a finger, etc. Generally, the computing system recognizes the touch and a position of the touch on the touch screen, and analyzes the touch, thereby performing operations accordingly.

A pressure sensor for detecting the touch pressure in the touch input device detects an output voltage between the reference potential layer and the pressure sensor and hereby calculates the capacitance value, thereby detecting the magnitude of the touch pressure. Here, instead of the capacitance value to be measured, the capacitance value including errors influenced by external factors is calculated. Therefore, this has a bad influence on the detection of the magnitude of the touch pressure.

### BRIEF SUMMARY

One embodiment is a touch input device that includes: a display panel; a pressure sensor which is disposed under the display panel; a reference potential layer which is disposed apart from the pressure sensor; and a controller which receives an output voltage from the pressure sensor and calculates a first capacitance value, and calculates a second capacitance value by removing a parasitic capacitance value from the first capacitance value. The controller receives the output voltage from the pressure sensor in a state where the reference potential layer is floating, and calculates the parasitic capacitance value.

In some embodiment of the present invention, the touch input device may further include a switching element which is electrically connected to the reference potential layer. The reference potential layer may be floating when the switching element is in an off-state.

In some embodiment of the present invention, the first capacitance value may be changed according to a distance change between the pressure sensor and the reference potential layer.

In some embodiment of the present invention, the reference potential layer may be located within the display panel, and the second capacitance value may be a capacitance value between the pressure sensor and the reference potential layer.

In some embodiment of the present invention, the touch input device may further include a frame disposed under and apart from the pressure sensor. The reference potential layer may be located in the frame. The second capacitance value may be a capacitance value between the pressure sensor and the reference potential layer.

In some embodiment of the present invention, the touch input device may further include a frame disposed under the pressure sensor, and the pressure sensor may be disposed apart from the display panel and the frame.

In some embodiment of the present invention, the reference potential layer may include a first reference potential layer and a second reference potential layer, and the first reference potential layer may be located within the display panel and the second reference potential layer may be located in the frame.

In some embodiment of the present invention, the second capacitance value may be calculated based on a capacitance value between the pressure sensor and the first reference potential layer and a capacitance value between the pressure sensor and the second reference potential layer.

In some embodiment of the present invention, the controller may calculate the first capacitance value in a first time interval, and the controller may calculate the parasitic capacitance value in a second time interval different from the first time interval.

In some embodiment of the present invention, the controller periodically may calculate the parasitic capacitance value.

In some embodiment of the present invention, the controller may be a touch controller IC or an application processor (AP).

Another embodiment is a touch input device that includes: a display panel; a pressure sensor which is disposed under the display panel; and a controller which receives an output voltage from the pressure sensor and calculates a first capacitance value, and calculates a second capacitance value by removing a parasitic capacitance value from the first capacitance value. The controller receives the output voltage from the pressure sensor in a state where the display panel has been assembled, and calculates the parasitic capacitance value.

Further another embodiment is a method for measuring a capacitance of a touch input device. The method includes: completing a display panel and forming a pressure sensor on the display panel; measuring a parasitic capacitance value of the display panel by using the pressure sensor; and combining the display panel and a frame.

In some embodiment of the present invention, the method may further include, after combining the display panel and the frame, measuring a third capacitance value through a pressure applied to the display panel by using the pressure sensor, and removing the parasitic capacitance value from the third capacitance value.

In some embodiment of the present invention, the parasitic capacitance value may be stored in a memory and used.

Yet another embodiment is a method for measuring a capacitance of a touch input device. The method includes: completing a frame and forming a pressure sensor on the frame; measuring a parasitic capacitance value of the frame by using the pressure sensor; and combining the display panel and a frame.

In some embodiment of the present invention, the method may further include, after combining the display panel and the frame, measuring a fourth cpacitance value through a pressure applied to the display panel by using the pressure sensor, and removing the parasitic capacitance value from the third capacitance value.

In some embodiment of the present invention, the parasitic capacitance value may be stored in a memory and used.

### BRIEF DESCRIPTION OF THE DRAWINGS

FIGS. 1a and 1b are schematic views showing a capacitive touch sensor included in a touch input device and the operation thereof in accordance with an embodiment of the present invention;

FIG. 2 shows a control block for controlling a touch position, touch pressure, and display operation in the touch input device according to the embodiment of the present invention;

FIGS. 3a and 3b are conceptual views for describing a configuration of a display module in the touch input device according to the embodiment of the present invention;

FIGS. 4a to 4g show an example in which a pressure sensor is formed in the touch input device according to the embodiment of the present invention;

FIG. 5 shows a cross section of a sensor sheet according to the embodiment of the present invention;

FIGS. 6a to 6c are cross sectional views showing an example in which the pressure sensor is directly formed in various display panels in the touch input device according to the embodiment of the present invention;

FIGS. 7a to 7c are cross sectional views illustratively showing a parasitic capacitance value in the touch input device according to the embodiment of the present invention;

FIGS. 8a to 8d are views showing a form of a sensor included in the touch input device according to the embodiment of the present invention; and

FIGS. 9a to 9d show various configuration of the control block included in the touch input device according to the embodiment of the present invention.

### DETAILED DESCRIPTION

The features, advantages and method for accomplishment of the present invention will be more apparent from referring to the following detailed embodiments described as well as the accompanying drawings. However, the present invention is not limited to the embodiment to be disclosed below and is implemented in different and various forms. The embodiments bring about the complete disclosure of the present invention and are only provided to make those skilled in the art fully understand the scope of the present invention. The present invention is just defined by the scope of the appended claims.

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Similar reference numerals in the drawings designate the same or similar functions in many aspects.

Unless differently defined, all terms used herein including technical and scientific terms have the same meaning as commonly understood by one of ordinary skill in the art to which the present invention belongs. Also, commonly used terms defined in the dictionary should not be ideally or excessively construed as long as the terms are not clearly and specifically defined in the present application.

Hereinafter, a touch input device capable detecting a pressure in accordance with an embodiment of the present invention will be described with reference to the accompanying drawings. Hereinafter, while a capacitive touch sensor 10 is exemplified below, a touch sensor can be applied which is capable of detecting a touch position in any manner.

A capacitance value that is sensed by a pressure sensor includes a parasitic capacitance value caused by external factors. Therefore, it is necessary to remove the parasitic capacitance value from the measured capacitance value, so that a pressure magnitude of the touch applied to a touch surface should be affected only by a capacitance value between the pressure sensor and a reference potential layer.

The embodiment of the present invention solves the problem by providing a method for separately calculating the parasitic capacitance value and provides a method for accurately measuring the magnitude of the touch pressure of the touch input device.

First, embodiments of the configurations of a plurality of the touch input devices that can be applied to the touch input device according to the embodiment of the present invention will be described.

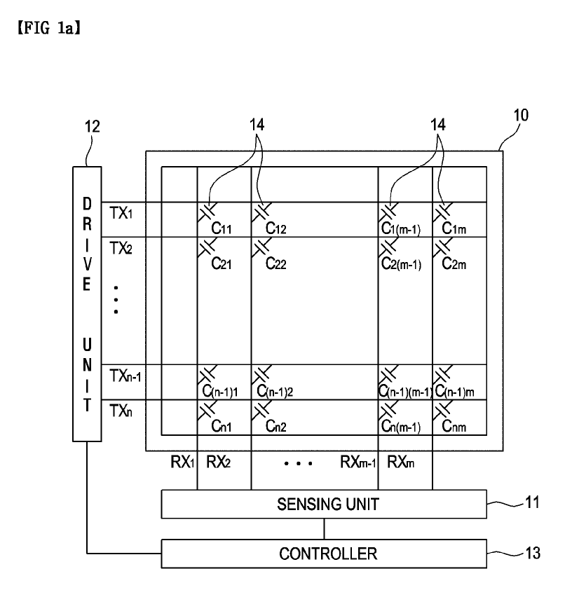

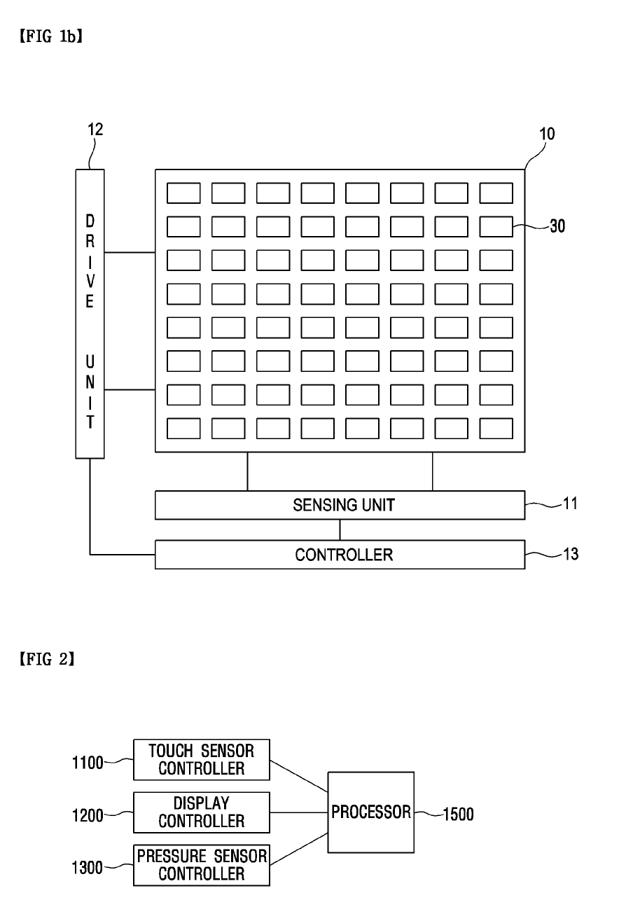

FIG. 1a is a schematic view showing a capacitive touch sensor included in a touch input device and the operation thereof in accordance with an embodiment of the present invention.

Referring to FIG. 1a, the touch sensor 10 may include a plurality of drive electrodes TX1 to TXn and a plurality of receiving electrodes RX1 to RXm. The touch sensor panel 100 may include a drive unit 12 which applies a drive signal to the plurality of drive electrodes TX1 to TXn for the purpose of the operation of the touch sensor 10, and a sensing unit 11 which detects whether the touch has occurred or not and a touch position by receiving a sensing signal including information on the capacitance change amount changing according to the touch on a touch surface from the plurality of receiving electrodes RX1 to RXm.

As shown in FIG. 1a, the touch sensor 10 may include the plurality of drive electrodes TX1 to TXn and the plurality of receiving electrodes RX1 to RXm. While FIG. 2a shows that the plurality of drive electrodes TX1 to TXn and the plurality of receiving electrodes RX1 to RXm of the touch sensor 10 form an orthogonal array, the present invention is not limited to this. The plurality of drive electrodes TX1 to TXn and the plurality of receiving electrodes RX1 to RXm has an array of arbitrary dimension, for example, a diagonal array, a concentric array, a 3-dimensional random array, etc., and an array obtained by the application of them. Here, “n” and “m” are positive integers and may be the same as each other or may have different values. The magnitudes of the values may be changed according to the embodiment.

The plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

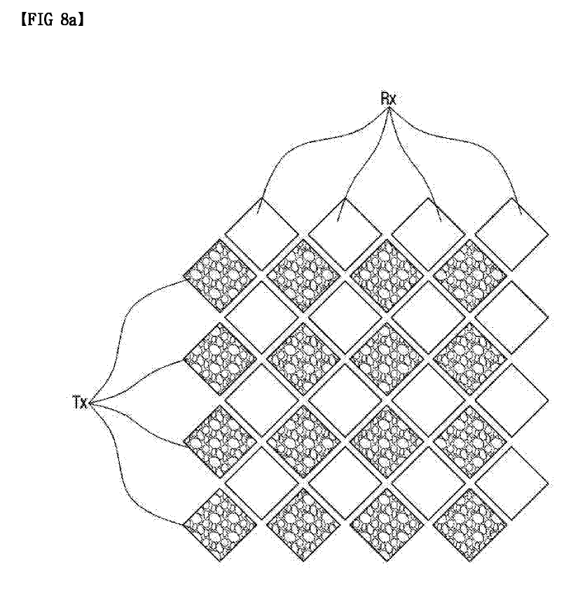

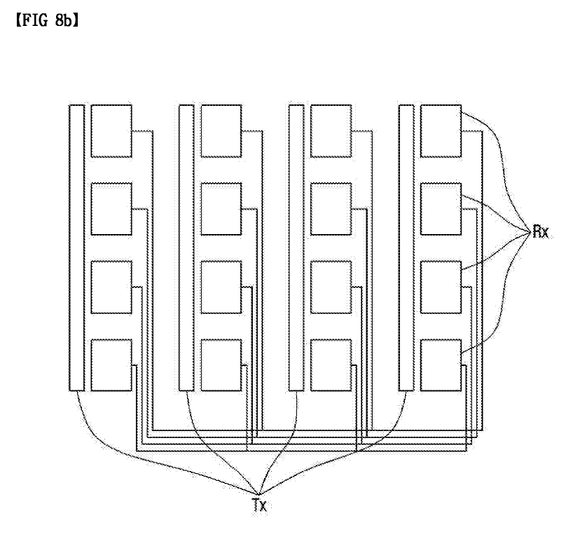

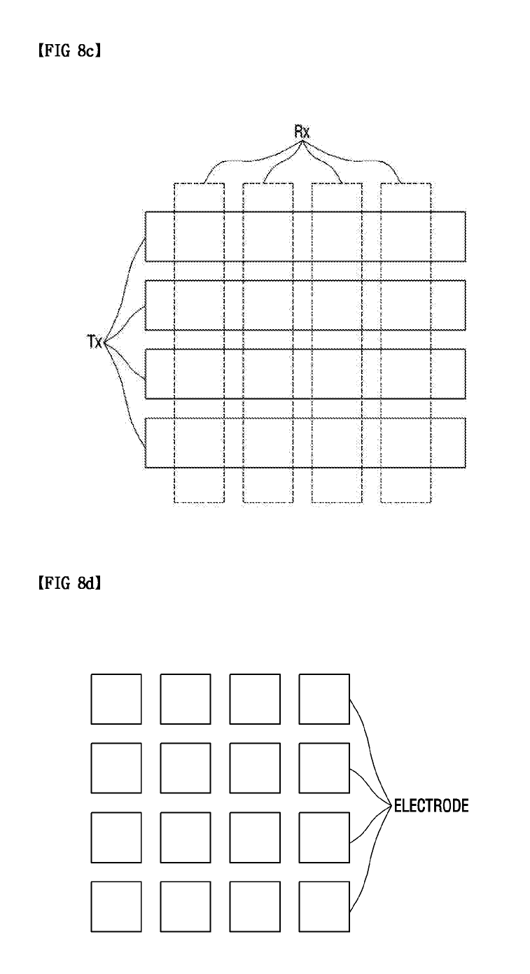

As shown in FIGS. 8a and 8b, in the touch sensor 10 according to the embodiment of the present invention, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on the top surface of a below-described display panel 200A.

Also, as shown in FIG. 8c, the plurality of drive electrodes TX1 to TXn and the plurality of receiving electrodes RX1 to RXm may be formed in different layers. For example, one of the plurality of drive electrodes TX1 to TXn and the plurality of receiving electrodes RX1 to RXm may be formed on the top surface of the display panel 200A, and the other may be formed on the bottom surface of a below-described cover or within the display panel 200A.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO2), and indium oxide (In2O3), etc.), or the like. However, this is only an example. The drive electrode TX and the receiving electrode RX may be also made of another transparent conductive material or an opaque conductive material. For instance, the drive electrode TX and the receiving electrode RX may be formed to include at least any one of silver ink, copper, nano silver, or carbon nanotube (CNT). Also, the drive electrode TX and the receiving electrode RX may be made of metal mesh.

The drive unit 12 according to the embodiment of the present invention may apply a drive signal to the drive electrodes TX1 to TXn. In the embodiment, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 11 receives the sensing signal including information on a capacitance (Cm) 14 generated between the receiving electrodes RX1 to RXm and the drive electrodes TX1 to TXn to which the drive signal has been applied, thereby detecting whether or not the touch has occurred and the touch position. For example, the sensing signal may be a signal coupled by the capacitance (Cm) 14 generated between the receiving electrode RX and the drive electrode TX to which the drive signal has been applied. As such, the process of sensing the drive signal applied from the first drive electrode TX1 to the n-th drive electrode TXn through the receiving electrodes RX1 to RXm can be referred to as a process of scanning the touch sensor 10.

For example, the sensing unit 11 may include a receiver (not shown) which is connected to each of the receiving electrodes RX1 to RXm through a switch. The switch becomes the on-state in a time interval during which the signal of the corresponding receiving electrode RX is sensed, thereby allowing the receiver to sense the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (CM) 14, and then converts the integrated current signal into voltage.

The sensing unit 11 may further include an analog to digital converter (ADC) (not shown) which converts the integrated data by the receiver into digital data. Later, the digital data may be input to a processor (not shown) and processed to obtain information on the touch on the touch sensor 10. The sensing unit 11 may include the ADC and processor as well as the receiver.

A controller 13 may perform a function of controlling the operations of the drive unit 12 and the sensing unit 11. For example, the controller 13 generates and transmits a drive control signal to the drive unit 12, so that the drive signal can be applied to a predetermined drive electrode TX1 for a predetermined time period. Also, the controller 13 generates and transmits the sense control signal to the sensing unit 11, so that the sensing unit 11 may receive the sensing signal from the predetermined receiving electrode RX for a predetermined time period and perform a predetermined function.

In FIG. 1a, the drive unit 12 and the sensing unit 11 may constitute a touch detection device (not shown) capable of detecting whether the touch has occurred on the touch sensor 10 or not and where the touch has occurred. The touch detection device may further include the controller 13. The touch detection device may be integrated and implemented on a touch sensing integrated circuit IC which corresponds to a below-described touch sensor controller 1100 in the touch input device including the touch sensor 10. The drive electrode TX and the receiving electrode RX included in the touch sensor 10 may be connected to the drive unit 12 and the sensing unit 11 included in touch sensing IC through, for example, a conductive trace and/or a conductive pattern printed on a circuit board, or the like. The touch sensing IC may be placed on a circuit board on which the conductive pattern has been printed, for example, a touch circuit board (hereinafter, referred to as a touch PCB). According to the embodiment, the touch sensing IC may be mounted on a main board for operation of the touch input device.

As described above, a capacitance (Cm) with a predetermined value is formed at each crossing of the drive electrode TX and the receiving electrode RX. When an object such as a finger approaches close to the touch sensor 10, the value of the capacitance may be changed. In FIG. 1a, the capacitance may represent a mutual capacitance (Cm). The sensing unit 11 detects such electrical characteristics, thereby detecting whether or not the touch has occurred on the touch sensor 10 and/or where the touch has occurred. For example, the sensing unit 11 is able to detect whether the touch has occurred on the surface of the touch sensor 10 comprised of a two-dimensional plane consisting of a first axis and a second axis and/or where the touch has occurred.

More specifically, when the touch occurs on the touch sensor 10, the drive electrode TX to which the drive signal has been applied is detected, so that the position of the second axial direction of the touch can be detected. Likewise, when the touch occurs on the touch sensor 10, the capacitance change is detected from the reception signal received through the receiving electrode RX, so that the position of the first axial direction of the touch can be detected.

Although the foregoing has described the operation method of the touch sensor 10 detecting the touch position on the basis of the mutual capacitance change amount between the drive electrode TX and the receiving electrode RX, the embodiment of the present invention is not limited to this. That is, as shown in FIG. 1b, it is also possible to detect the touch position on the basis of a self-capacitance change amount.

FIG. 1b is a schematic view for describing another capacitive touch sensor included in a touch input device according to another embodiment of the present invention and the operation thereof.

A plurality of touch electrodes 30 are provided on the touch sensor 10 shown in FIG. 1b. Although the plurality of touch electrodes 30 may be, as shown in FIG. 8d, disposed at a regular interval in the form of a grid, the present invention is not limited to this.

The drive control signal generated by the controller 13 is transmitted to the drive unit 12. On the basis of the drive control signal, the drive unit 12 applies the drive signal to the predetermined touch electrode 30 for a predetermined time period. Also, the sense control signal generated by the controller 13 is transmitted to the sensing unit 11. On the basis of the sense control signal, the sensing unit 11 receives the sensing signal from the predetermined touch electrode 30 for a predetermined time period. Here, the sensing signal may be a signal for the change amount of the self-capacitance formed on the touch electrode 30.

Here, whether the touch has occurred on the touch sensor 10 or not and/or the touch position are detected by the sensing signal detected by the sensing unit 11. For example, since the coordinate of the touch electrode 30 has been known in advance, whether the touch of the object on the surface of the touch sensor 10 has occurred or not and/or the touch position can be detected.

In the foregoing, for convenience of description, it has been described that the drive unit 12 and the sensing unit 11 operate individually as a separate block. However, the operation to apply the drive signal to the touch electrode 30 and to receive the sensing signal from the touch electrode 30 can be also performed by one drive and sensing unit.

The foregoing has described in detail the capacitance type touch sensor as the touch sensor 10. However, in the touch input device 1000 according to the embodiment of the present invention, the touch sensor 10 for detecting whether or not the touch has occurred and the touch position may be implemented by using not only the above-described method but also any touch sensing method such as a surface capacitance type method, a projected capacitance type method, a resistance film method, a surface acoustic wave (SAW) method, an infrared method, an optical imaging method, a dispersive signal technology, and an acoustic pulse recognition method, etc.

FIG. 2 shows a control block for controlling the touch position, a touch pressure and a display operation in the touch input device according to the embodiment of the present invention. In the touch input device 1000 configured to detect the touch pressure in addition to the display function and touch position detection, the control block may include the above-described touch sensor controller 1100 for detecting the touch position, a display controller 1200 for driving the display panel, and a pressure sensor controller 1300 for detecting the pressure.

The display controller 1200 may include a control circuit which receives an input from an application processor (AP) or a central processing unit (CPU) on a main board for the operation of the touch input device 1000 and displays the contents that the user wants on the display panel 200A. The control circuit may be mounted on a display circuit board (hereafter, referred to as a display PCB). The control circuit may include a display panel control IC, a graphic controller IC, and a circuit required to operate other display panel 200A.

The pressure sensor controller 1300 for detecting the pressure through a pressure sensor unit may be configured similarly to the touch sensor controller 1100, and thus, may operate similarly to the touch sensor controller 1100. Specifically, as shown in FIGS. 1a and 1b, the pressure sensor controller 1300 may include the drive unit, the sensing unit, and the controller, and may detect a magnitude of the pressure by the sensing signal sensed by the sensing unit. Here, the pressure sensor controller 1300 may be mounted on the touch PCB on which the touch sensor controller 1100 has been mounted or may be mounted on the display PCB on which the display controller 1200 has been mounted.

According to the embodiment, the touch sensor controller 1100, the display controller 1200, and the pressure sensor controller 1300 may be included as different components in the touch input device 1000. For example, the touch sensor controller 1100, the display controller 1200, and the pressure sensor controller 1300 may be composed of different chips respectively. Here, a processor 1500 of the touch input device 1000 may function as a host processor for the touch sensor controller 1100, the display controller 1200, and the pressure sensor controller 1300.

The touch input device 1000 according to the embodiment of the present invention may include an electronic device including a display screen and/or a touch screen, such as a cell phone, a personal data assistant (PDA), a smartphone, a tablet personal computer (PC).

In order to manufacture such a thin and lightweight touch input device 1000, the touch sensor controller 1100, the display controller 1200, and the pressure sensor controller 1300, which are, as described above, formed separately from each other, may be integrated into one or more configurations in accordance with the embodiment of the present invention. In addition to this, these controllers can be integrated into the processor 1500 respectively. Also, according to the embodiment of the present invention, the touch sensor 10 and/or the pressure sensing unit may be integrated into the display panel 200A.

In the touch input device 1000 according to the embodiment of the present invention, the touch sensor 10 for detecting the touch position may be positioned outside or inside the display panel 200A. The display panel 200A of the touch input device 1000 according to the embodiment of the present invention may be a display panel included in a liquid crystal display (LCD), a plasma display panel (PDP), an organic light emitting diode (OLED), etc. Accordingly, a user may perform the input operation by touching the touch surface while visually identifying an image displayed on the display panel.

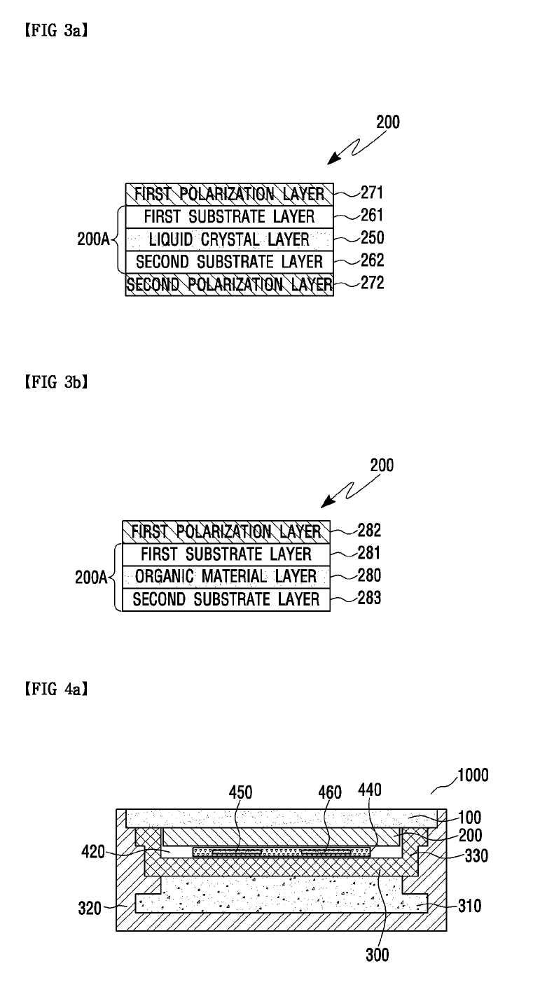

FIGS. 3a and 3b are conceptual views for describing a configuration of a display module in the touch input device according to the embodiment of the present invention.

First, the configuration of a display module 200 including the display panel 200A using an LCD panel will be described with reference to FIG. 3a.

As shown in FIG. 3a, the display module 200 may include the display panel 200A that is an LCD panel, a first polarization layer 271 disposed on the display panel 200A, and a second polarization layer 272 disposed under the display panel 200A. The display panel 200A that is an LCD panel may include a liquid crystal layer 250 including a liquid crystal cell, a first substrate layer 261 disposed on the liquid crystal layer 250, and a second substrate layer 262 disposed under the liquid crystal layer 250.

Here, the first substrate layer 261 may be made of color filter glass, and the second substrate layer 262 may be made of TFT glass. Also, according to the embodiment, at least one of the first substrate layer 261 and the second substrate layer 262 may be made of a bendable material such as plastic. In FIG. 3a, the second substrate layer 262 may be comprised of various layers including a data line, a gate line, TFT, a common electrode, and a pixel electrode, etc. These electrical components may operate in such a manner as to generate a controlled electric field and orient liquid crystals located in the liquid crystal layer 250.

Next, the configuration of the display module 200 including the display panel 200A using an OLED panel will be described with reference to FIG. 3b.

As shown in FIG. 3b, the display module 200 may include the display panel 200A that is an OLED panel, and a first polarization layer 282 disposed on the display panel 200A. The display panel 200A that is an OLED panel may include an organic material layer 280 including an organic light-emitting diode (OLED), a first substrate layer 281 disposed on the organic material layer 280, and a second substrate layer 283 disposed under the organic material layer 280.

Here, the first substrate layer 281 may be made of encapsulation glass, and the second substrate layer 283 may be made of TFT glass. Also, according to the embodiment, at least one of the first substrate layer 281 and the second substrate layer 283 may be made of a bendable material such as plastic. The OLED panel shown in FIG. 3b may include an electrode used to drive the display panel 200A, such as a gate line, a data line, a first power line (ELVDD), a second power line (ELVSS), etc. The organic light-emitting diode (OLED) panel is a self-light emitting display panel which uses a principle where, when current flows through a fluorescent or phosphorescent organic thin film and then electrons and electron holes are combined in the organic material layer, so that light is generated. The organic material constituting the light emitting layer determines the color of the light.

Specifically, the OLED uses a principle in which when electricity flows and an organic matter is applied on glass or plastic, the organic matter emits light. That is, the principle is that electron holes and electrons are injected into the anode and cathode of the organic matter respectively and are recombined in the light emitting layer, so that a high energy exciton is generated and the exciton releases the energy while falling down to a low energy state and then light with a particular wavelength is generated. Here, the color of the light is changed according to the organic matter of the light emitting layer.

The OLED includes a line-driven passive-matrix organic light-emitting diode (PM-OLED) and an individual driven active-matrix organic light-emitting diode (AM-OLED) in accordance with the operating characteristics of a pixel constituting a pixel matrix. None of them require a backlight. Therefore, the OLED enables a very thin display module to be implemented, has a constant contrast ratio according to an angle and obtains good color reproductivity depending on a temperature. Also, it is very economical in that non-driven pixel does not consume power.

In terms of operation, the PM-OLED emits light only during a scanning time at a high current, and the AM-OLED maintains a light emitting state only during a frame time at a low current. Therefore, the AM-OLED has a resolution higher than that of the PM-OLED and is advantageous for driving a large area display panel and consumes low power. Also, a thin film transistor (TFT) is embedded in the AM-OLED, and thus, each component can be individually controlled, so that it is easy to implement a delicate screen.

Also, the organic material layer 280 may include a hole injection layer (HIL), a hole transport layer (HTL), an electron injection layer (EIL), an electron transport layer (ETL), and an emission material layer (EML).

Briefly describing each of the layers, HIL injects electron holes and is made of a material such as CuPc, etc. HTL functions to move the injected electron holes and mainly is made of a material having a good hole mobility. The HTL may be made of Arylamine, TPD, and the like. The EIL and ETL inject and transport electrons. The injected electrons and electron holes are combined in the EML and emit light. The EML represents the color of the emitted light and is composed of a host determining the lifespan of the organic matter and an impurity (dopant) determining the color sense and efficiency. This just describes the basic structure of the organic material layer 280 include in the OLED panel. The present invention is not limited to the layer structure or material, etc., of the organic material layer 280.

The organic material layer 280 is inserted between an anode (not shown) and a cathode (not shown). When the TFT becomes an on-state, a driving current is applied to the anode and the electron holes are injected, and the electrons are injected to the cathode. Then, the electron holes and electrons move to the organic material layer 280 and emit the light.

It will be apparent to a skilled person in the art that the LCD panel or the OLED panel may further include other structures so as to perform the display function and may be deformed.

The display module 200 of the touch input device 1000 according to the embodiment of the present invention may include the display panel 200A and a configuration for driving the display panel 200A. Specifically, when the display panel 200A is an LCD panel, the display module 200 may include a backlight unit (not shown) disposed under the second polarization layer 272 and may further include a display panel control IC for operation of the LCD panel, a graphic control IC, and other circuits.

In the touch input device 1000 according to the embodiment of the present invention, the touch sensor 10 for detecting the touch position may be positioned outside or inside the display module 200.

When the touch sensor 10 in the touch input device 1000 positioned outside the display module 200, the touch sensor panel may be disposed on the display module 200, and the touch sensor 10 may be included in the touch sensor panel. The touch surface of the touch input device 1000 may be the surface of the touch sensor panel.

When the touch sensor 10 in the touch input device 1000 positioned inside the display module 200, the touch sensor 10 may be configured to be positioned outside the display panel 200A. Specifically, the touch sensor 10 may be formed on the top surfaces of the first substrate layers 261 and 281. Here, the touch surface of the touch input device 1000 may be an outer surface of the display module 200 and may be the top surface or bottom surface in FIGS. 3 and 3b.

When the touch sensor 10 in the touch input device 1000 is positioned inside the display module 200, at least a portion of the touch sensor 10 may be configured to be positioned inside the display panel 200A, and at least a portion of the remaining touch sensor 10 may be configured to be positioned outside the display panel 200A.

For example, any one of the drive electrode TX and the receiving electrode RX, which constitute the touch sensor 10, may be configured to be positioned outside the display panel 200A, and the other may be configured to be positioned inside the display panel 200A. Specifically, any one of the drive electrode TX and the receiving electrode RX, which constitute the touch sensor 10, may be formed on the top surface of the top surfaces of the first substrate layers 261 and 281, and the other may be formed on the bottom surfaces of the first substrate layers 261 and 281 or may be formed on the top surfaces of the second substrate layers 262 and 283.

When the touch sensor 10 in the touch input device 1000 positioned inside the display module 200, the touch sensor 10 may be configured to be positioned inside the display panel 200A. Specifically, the touch sensor 10 may be formed on the bottom surfaces of the first substrate layers 261 and 281 or may be formed on the top surfaces of the second substrate layers 262 and 283.

When the touch sensor 10 is positioned inside the display panel 200A, an electrode for operation of the touch sensor may be additionally disposed. However, various configurations and/or electrodes positioned inside the display panel 200A may be used as the touch sensor 10 for sensing the touch.

Specifically, when the display panel 200A is the LCD panel, at least any one of the electrodes included in the touch sensor 10 may include at least any one of a data line, a gate line, TFT, a common electrode (Vcom), and a pixel electrode. When the display panel 200A is the OLED panel, at least any one of the electrodes included in the touch sensor 10 may include at least any one of a data line, a gate line, a first power line (ELVDD), and a second power line (ELVSS).

Here, the touch sensor 10 may function as the drive electrode and the receiving electrode described in FIG. 1a and may detect the touch position in accordance with the mutual capacitance between the drive electrode and the receiving electrode. Also, the touch sensor 10 may function as the single electrode 30 described in FIG. 1b and may detect the touch position in accordance with the self-capacitance of each of the single electrodes 30. Here, if the electrode included in the touch sensor 10 is used to drive the display panel 200A, the display panel 200A may be driven in a first time interval and the touch position may be detected in a second time interval different from the first time interval.

Hereinafter, the following detailed description will be provided by taking an example of a case where a separate sensor which is different from the electrode used to detect the touch position and the electrode used to drive the display is disposed and used as the pressure sensing unit, in order to detect the touch pressure in the touch input device according to the embodiment of the present invention.

In the touch input device 1000 according to the embodiment of the present invention, by means of an adhesive like an optically clear adhesive (OCA), lamination may occur between a cover layer 100 on which the touch sensor for detecting the touch position has been formed and the display module 200 including the display panel 200A. As a result, the display color clarity, visibility and optical transmittance of the display module 200, which can be recognized through the touch surface of the touch sensor, can be improved.

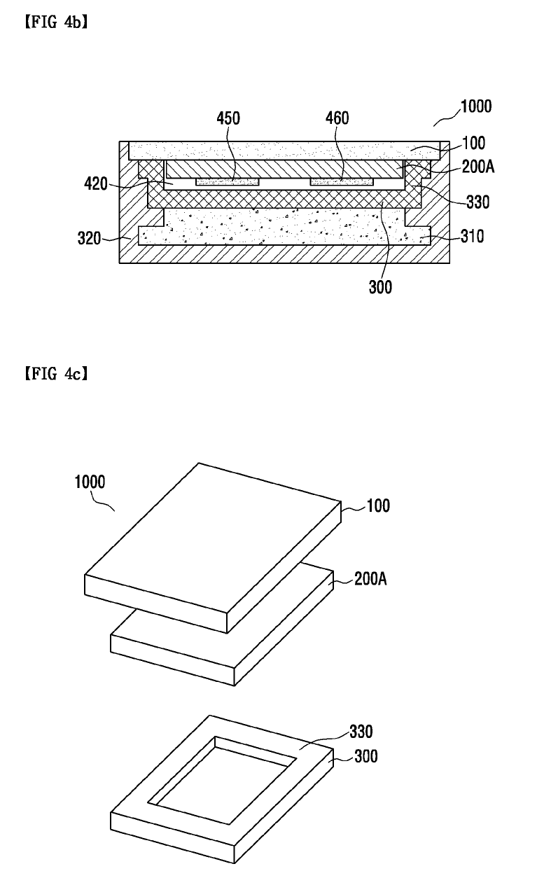

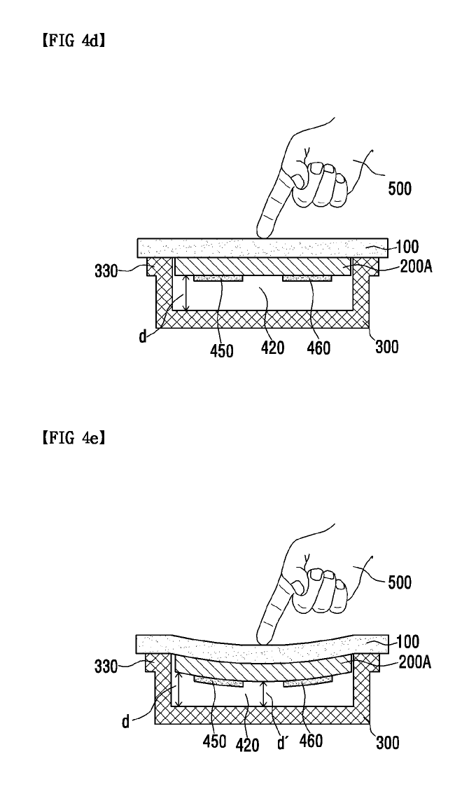

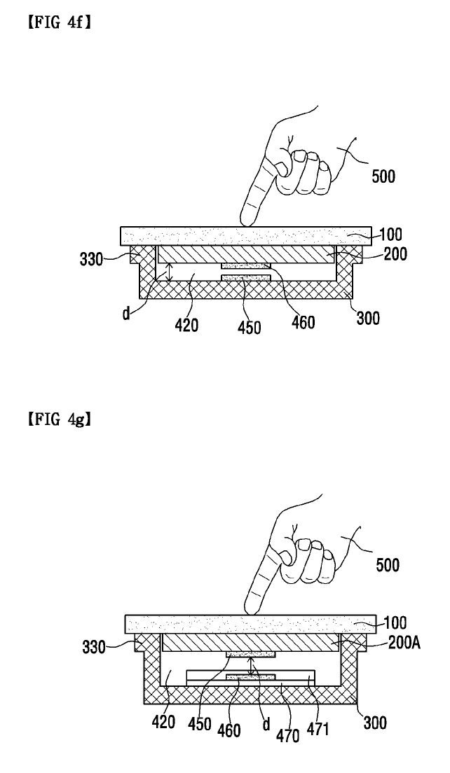

FIGS. 4a to 4g show an example in which the pressure sensor is formed in the touch input device according to the embodiment of the present invention.

In FIG. 4a and some of the following figures, it is shown that the display panel 200A is directly laminated on and attached to the cover layer 100. However, this is only for convenience of description. The display module 200 where the first polarization layers 271 and 282 is located on the display panel 200A may be laminated on and attached to the cover layer 100. When the LCD panel is the display panel 200A, the second polarization layer 272 and the backlight unit are omitted.

In the description with reference to FIGS. 4a to 4g, it is shown that as the touch input device 1000 according to the embodiment of the present invention, the cover layer 100 in which the touch sensor has been formed is laminated on and attached to the display module 200 shown in FIGS. 3a and 3b by means of an adhesive. However, the touch input device 1000 according to the embodiment of the present invention may include that the touch sensor 10 is disposed inside the display module 200 shown in FIGS. 3a and 3b.

More specifically, while FIGS. 4a to 4d show that the cover layer 100 where the touch sensor 10 has been formed covers the display module 200 including the display panel 200A, the touch input device 1000 which includes the touch sensor 10 disposed inside the display module 200 and includes the display module 200 covered with the cover layer 100 like glass may be used as the embodiment of the present invention.

The touch input device 1000 according to the embodiment of the present invention may include an electronic device including the touch screen, for example, a cell phone, a personal data assistant (PDA), a smart phone, a tablet personal computer, an MP3 player, a laptop computer, etc.

In the touch input device 1000 according to the embodiment of the present invention, a substrate 300, together with an outermost housing 320 of the touch input device 1000, may function to surround a mounting space 310, etc., where the circuit board and/or battery for operation of the touch input device 1000 are placed. Here, the circuit board for operation of the touch input device 1000 may be a main board. A central processing unit (CPU), an application processor (AP) or the like may be mounted on the circuit board. Due to the substrate 300, the display module 200 is separated from the circuit board and/or battery for operation of the touch input device 1000. Due to the substrate 300, electrical noise generated from the display module 200 and noise generated from the circuit board can be blocked.

The touch sensor 10 or the cover layer 100 of the touch input device 1000 may be formed wider than the display module 200, the substrate 300, and the mounting space 310. As a result, the housing 320 may be formed such that the housing 320, together with the touch sensor 10, surrounds the display module 200, the substrate 300, and the circuit board.

The touch input device 1000 according to the embodiment of the present invention may detect the touch position through the touch sensor 10 and may detect the touch pressure by placing a separate sensor and using it as the pressure sensing unit, which is different from the electrode used to detect the touch position and the electrode used to drive the display. Here, the touch sensor 10 may be disposed inside or outside the display module 200.

Hereafter, the components for detecting the pressure are collectively referred to as the pressure sensing unit. For example, the pressure sensing unit of the embodiment shown in FIG. 4a may include a sensor sheet 440, and the pressure sensing unit of the embodiment shown in FIG. 4b may include pressure sensors 450 and 460.

In the touch input device according to the embodiment of the present invention, as shown in FIG. 4a, the sensor sheet 440 including the pressure sensors 450 and 460 may be disposed between the display module 200 and the substrate 300, or alternatively, as shown in FIG. 4b, the pressure sensors 450 and 460 may be directly formed on the bottom surface of the display panel 200A. Here, the sensor sheet 440 may be attached to the bottom surface of the display module 200, and the spacer layer 420 may be disposed between the sensor sheet 440 and the substrate 300. Alternatively, the sensor sheet 440 may be attached to the top surface of the substrate 300, and the spacer layer 420 may be disposed between the sensor sheet 440 and the display module 200.

The pressure sensing unit is formed to include, for example, the spacer layer 420 composed of an air gap. This will be described in detail with reference to FIGS. 4a to 4g.

According to the embodiment, the spacer layer 420 may be implemented by the air gap. According to the embodiment, the spacer layer 420 may be made of an impact absorbing material. According to the embodiment, the spacer layer 420 may be filled with a dielectric material. According to the embodiment, the spacer layer 420 may be made of a material having a restoring force by which the material contracts by applying the pressure and returns to its original shape by releasing the pressure. According to the embodiment, the spacer layer 420 may be made of elastic foam. Also, since the spacer layer is disposed under the display module 200, the spacer layer may be made of a transparent material or an opaque material.

Also, a reference potential layer may be disposed under the display module 200. Specifically, the reference potential layer may be formed on the substrate 300 disposed under the display module 200. Alternatively, the substrate 300 itself may serve as the reference potential layer. Also, the reference potential layer may be disposed on the cover (not shown) which is disposed on the substrate 300 and under the display module 200 and functions to protect the display module 200. Alternatively, the cover itself may serve as the reference potential layer.

When a pressure is applied to the touch input device 1000, the display panel 200A is bent. Due to the bending of the display panel 200A, a distance between the reference potential layer and the pressure sensor 450 and 460 may be changed. Also, the spacer layer may be disposed between the reference potential layer and the pressure sensor 450 and 460. Specifically, the spacer layer may be disposed between the display module 200 and the substrate 300 where the reference potential layer has been disposed or between the display module 200 and the cover where the reference potential layer has been disposed.

Also, the reference potential layer may be disposed inside the display module 200. Specifically, the reference potential layer may be disposed on the top surfaces or bottom surfaces of the first substrate layers 261 and 281 of the display panel 200A or on the top surfaces or bottom surfaces of the second substrate layers 262 and 283. When a pressure is applied to the touch input device 1000, the display panel 200A is bent. Due to the bending of the display panel 200A, the distance between the reference potential layer and the pressure sensor 450 and 460 may be changed. Also, the spacer layer may be disposed between the reference potential layer and the pressure sensor 450 and 460. In the case of the touch input device 1000 shown in FIGS. 3a and 3b, the spacer layer may be disposed on or within the display panel 200A.

Likewise, according to the embodiment, the spacer layer may be implemented by the air gap. According to the embodiment, the spacer layer may be made of the impact absorbing material. According to the embodiment, the spacer layer may be filled with a dielectric material. According to the embodiment, the spacer layer may be made of a material having a restoring force by which the material contracts by applying the pressure and returns to its original shape by releasing the pressure. According to the embodiment, the spacer layer may be made of elastic foam. Also, since the spacer layer is disposed on or within the display panel 200A, the spacer layer may be made of a transparent material.

According to the embodiment, when the spacer layer is disposed inside the display module 200, the spacer layer may be the air gap which is included during the manufacture of the display panel 200A and/or the backlight unit. When the display panel 200A and/or the backlight unit includes one air gap, the one air gap may function as the spacer layer. When the display panel 200A and/or the backlight unit includes a plurality of the air gaps, the plurality of air gaps may collectively function as the spacer layer.

FIG. 4c is a perspective view of the touch input device 1000 according to the embodiment shown in FIG. 4a. As shown in FIG. 4c, the sensor sheet 440 of the embodiment may be disposed between the display module 200 and the substrate 300 in the touch input device 1000. Here, the touch input device 1000 may include the spacer layer disposed between the display module 200 and the substrate 300 in order to dispose the sensor sheet 440.

Hereafter, for the purpose of clearly distinguishing the electrodes 450 and 460 from the electrode included in the touch sensor 10, the sensors 450 and 460 for detecting the pressure are designated as pressure sensors 450 and 460. Here, since the pressure sensors 450 and 460 are disposed in the rear side instead of in the front side of the display panel 200A, the pressure sensor 450 and 460 may be made of an opaque material as well as a transparent material. When the display panel 200A is the LCD panel, the light from the backlight unit must transmit through the pressure sensors 450 and 460. Therefore, the pressure sensors 450 and 460 may be made of a transparent material such as ITO.

Here, a frame 330 having a predetermined height may be formed along the border of the upper portion of the substrate 300 in order to maintain the spacer layer 420 in which the pressure sensor 450 and 460 are disposed. Here, the frame 330 may be bonded to the cover layer 100 by means of an adhesive tape (not shown). While FIG. 4c shows the frame 330 is formed on the entire border (e.g., four sides of the quadrangle) of the substrate 300, the frame 330 may be formed only on at least some (e.g., three sides of the quadrangle) of the border of the substrate 300.

According to the embodiment, the frame 330 may be formed on the top surface of the substrate 300 may be integrally formed with the substrate 300 on the top surface of the substrate 300. In the embodiment of the present invention, the frame 330 may be made of an inelastic material. In the embodiment of the present invention, when a pressure is applied to the display panel 200A through the cover layer 100, the display panel 200A, together with the cover layer 100, may be bent. Therefore, the magnitude of the touch pressure can be detected even though the frame 330 is not deformed by the pressure.

FIG. 4d is a cross sectional view of the touch input device including the pressure sensor according to the embodiment of the present invention. As shown in FIG. 4d, the pressure sensors 450 and 460 according to the embodiment of the present invention may be formed within the spacer layer 420 and on the bottom surface of the display panel 200A.

The pressure sensor for detecting the pressure may include the first sensor 450 and the second sensor 460. Here, any one of the first sensor 450 and the second sensor 460 may be a drive sensor, and the other may be a receiving sensor. A drive signal is applied to the drive sensor, and a sensing signal including information on electrical characteristics changing by applying the pressure may be obtained through the receiving sensor. For example, when a voltage is applied, a mutual capacitance may be generated between the first sensor 450 and the second sensor 460.

FIG. 4e is a cross sectional view when a pressure is applied to the touch input device 1000 shown in FIG. 4d. The top surface of the substrate 300 may have a ground potential so as to block the noise. When a pressure is applied to the surface of the cover layer 100 by an object 500, the cover layer 100 and the display panel 200A may be bent or pressed. As a result, a distance “d” between the ground potential surface and the pressure sensors 450 and 460 may be decreased to “d′”. In this case, due to the decrease of the distance “d”, the fringing capacitance is absorbed in the top surface of the substrate 300, so that the mutual capacitance between the first sensor 450 and the second sensor 460 may be reduced. Therefore, the magnitude of the touch pressure can be calculated by obtaining the reduction amount of the mutual capacitance from the sensing signal obtained through the receiving sensor.

Although it has been described in FIG. 4e that the top surface of the substrate 300 has the ground potential, that is to say, is the reference potential layer, the reference potential layer may be disposed inside the display module 200. Here, when a pressure is applied to the surface of the cover layer 100 by the object 500, the cover layer 100 and the display panel 200A may be bent or pressed. As a result, a distance between the pressure sensors 450 and 460 and the reference potential layer disposed inside the display module 200 is changed. Therefore, the magnitude of the touch pressure can be calculated by obtaining the capacitance change amount from the sensing signal obtained through the receiving sensor.

In the touch input device 1000 according to the embodiment of the present invention, the display panel 200A may be bent or pressed by the touch applying the pressure. When the display panel 200A is bent or pressed according to the embodiment, a position showing the biggest deformation may not match the touch position. However, the display panel 200A may be shown to be bent at least at the touch position. For example, when the touch position approaches close to the border, edge, etc., of the display panel 200A, the most bent or pressed position of the display panel 200A may not match the touch position, however, the display panel 200A may be shown to be bent or pressed at least at the touch position.

In the state where the first sensor 450 and the second sensor 460 are formed in the same layer, each of the first sensor 450 and the second sensor 460 shown in FIGS. 4d and 4e may be, as shown in FIG. 8a, composed of a plurality of lozenge-shaped sensors. Here, the plurality of first sensors 450 are connected to each other in the first axial direction, and the plurality of second sensors 460 are connected to each other in the second axial direction orthogonal to the first axial direction. The lozenge-shaped sensors of at least one of the first sensor 450 and the second sensor 460 are connected to each other through a bridge, so that the first sensor 450 and the second sensor 460 may be insulated from each other. Also, here, the first sensor 450 and the second sensor 460 shown in FIG. 5 may be composed of a sensor having a form shown in FIG. 8b.

In the foregoing, it is shown that the touch pressure is detected from the change of the mutual capacitance between the first sensor 450 and the second sensor 460. However, the pressure sensing unit may be configured to include only any one of the first sensor 450 and the second sensor 460. In this case, it is possible to detect the magnitude of the touch pressure by detecting the change of the capacitance between the one pressure sensor and a ground layer (the reference potential layer disposed inside the display module 200 or the substrate 300), that is to say, the change of the self-capacitance. Here, the drive signal is applied to the one pressure sensor, and the change of the self-capacitance between the pressure sensor and the ground layer can be detected by the pressure sensor.

For instance, in FIG. 4d, the pressure sensor may be configured to include only the first sensor 450. Here, the magnitude of the touch pressure can be detected by the change of the capacitance between the first sensor 450 and the substrate 300, which is caused by a distance change between the substrate 300 and the first sensor 450. Since the distance “d” is reduced with the increase of the touch pressure, the capacitance between the substrate 300 and the first sensor 450 may be increased with the increase of the touch pressure. Here, the plurality of first sensors 450 may be formed on the display panel 200A.

Here, the pressure sensor should not necessary have a comb teeth shape or a trident shape, which is required to improve the detection accuracy of the mutual capacitance change amount. The pressure sensor may have a plate shape (e.g., quadrangular plate). Or, as shown in FIG. 8d, the plurality of the first sensors 450 may be disposed at a regular interval in the form of a grid.

FIG. 4f shows that the pressure sensors 450 and 460 are formed within the spacer layer 420 and on the top surface of the substrate 300 and on the bottom surface of the display module 200. Here, when the pressure sensing unit is, as shown in FIG. 4a, comprised of the sensor sheet, the sensor sheet is composed of a first sensor sheet 440-1 including the first sensor 450 and a second sensor sheet 440-2 including the second sensor 460. Here, one of the first sensor 450 and the second sensor 460 may be formed on the substrate 300 and the other may be formed on the bottom surface of the display module 200. FIG. 4g shows that the first sensor 450 is formed on the substrate 300 and the second sensor 460 is formed on the bottom surface of the display module 200.

FIG. 4g shows that the pressure sensors 450 and 460 are formed within the spacer layer 420 and on the top surface of the substrate 300 and on the bottom surface of the display panel 200A. Here, the first sensor 450 may be formed on the bottom surface of the display panel 200A, and the second sensor 460 may be disposed on the top surface of the substrate 300 in the form of a sensor sheet in which the second sensor 460 is formed on a first insulation layer 470 and a second insulation layer 471 is formed on the second sensor 460.

When the object 500 applies a pressure to the surface of the cover layer 100, the cover layer 100 and the display panel 200A may be bent or pressed. As a result, a distance “d” between the first sensor 450 and the second sensor 460 may be reduced. In this case, the mutual capacitance between the first sensor 450 and the second sensor 460 may be increased with the reduction of the distance “d”. Therefore, the magnitude of the touch pressure can be calculated by obtaining the increase amount of the mutual capacitance from the sensing signal obtained through the receiving sensor.

Here, in FIG. 4g, since the first sensor 450 and the second sensor 460 are formed in different layers, the first sensor 450 and the second sensor 460 should not necessary have a comb teeth shape or a trident shape. Any one sensor of the first sensor 450 and the second sensor 460 may have a plate shape (e.g., quadrangular plate), and the other remaining plural sensors may be, as shown in FIG. 8d, disposed at a regular interval in the form of a grid.

While the foregoing has described that the pressure sensors 450 and 460 are, as shown in FIG. 4b, directly formed on the bottom surface of the display panel 200A, the embodiment in which the sensor sheet 440 including the pressure sensors 450 and 460 is, as shown in FIG. 4a, disposed between the display module 200 and the substrate 300 can be also applied.

In this case, the top surface of the substrate 300 may have the ground potential for shielding the noise.

FIG. 5 shows a cross section of the sensor sheet according to the embodiment of the present invention. Referring to (a) of FIG. 5, the cross sectional view shows that the sensor sheet 440 including the pressure sensors 450 and 460 has been attached to the substrate 300 or the display module 200. Here, a short-circuit can be prevented from occurring between the pressure electrodes 450 and 460 and either the substrate 300 or the display module 200 because the pressure sensors 450 and 460 are disposed between the first insulation layer 470 and the second insulation layer 471 in the sensor sheet 440.

Depending on the type and/or implementation method of the touch input device 1000, the substrate 300 or the display module 200 to which the pressure sensors 450 and 460 are attached may not have the ground potential or may have a weak ground potential. In this case, the touch input device 1000 according to the embodiment of the present invention may further include a ground electrode (not shown) between the insulation layer 470 and either the substrate 300 or the display module 200. According to the embodiment of the present invention, the touch input device 1000 invention may further include another insulation layer (not shown) between the ground electrode and either the substrate 300 or the display module 200. Here, the ground electrode (not shown) is able to prevent the size of the capacitance generated between the first sensor 450 and the second sensor 460, which are pressure sensors, from increasing excessively.

It is possible to consider that the first sensor 450 and the second sensor 460 are formed in different layers in accordance with the embodiment of the present invention so that a sensor layer is formed. In (b) of FIG. 5, the cross sectional view shows that the first sensor 450 and the second sensor 460 are formed in different layers. As shown in (b) of FIG. 5, the first sensor 450 may be formed on the first insulation layer 470, and the second sensor 460 may be formed on the second insulation layer 471 located on the first sensor 450. According to the embodiment of the present invention, the second sensor 460 may be covered with a third insulation layer 472.

In other words, the sensor sheet 440 may include the first to third insulation layers 470 to 472, the first sensor 450, and the second sensor 460. Here, the first sensor 450 and the second sensor 460 may be implemented so as to overlap each other because they are disposed in different layers. For example, the first sensor 450 and the second sensor 460 may be, as shown in FIG. 8c, formed similarly to the pattern of the drive electrode TX and receiving electrode RX which are arranged in the form of M×N array. Here, M and N may be natural numbers greater than 1. Also, as shown in FIG. 8a, the lozenge-shaped first sensor 450 and the lozenge-shaped second sensor 460 may be located in different layers respectively.

In (c) of FIG. 5, the cross sectional view shows that the sensor sheet 440 is implemented to include only the first sensor 450. As shown in (c) of FIG. 5, the sensor sheet 440 including the first sensor 450 may be disposed on the substrate 300 or the display module 200.

In (d) of FIG. 5, the cross sectional view shows that the first sensor sheet 440-1 including the first sensor 450 is attached to the substrate 300, and the second sensor sheet 440-2 including the second sensor 460 is attached to the display module 200. As shown in (d) of FIG. 5, the first sensor sheet 440-1 including the first sensor 450 may be disposed on the substrate 300. Also, the second sensor sheet 440-2 including the second sensor 460 may be disposed on the bottom surface of the display module 200.

As with the description related to (a) of FIG. 5, when the substrate 300 or the display module 200 to which the pressure sensors 450 and 460 are attached may not have the ground potential or may have a weak ground potential, the sensor sheet 440 in (a) to (d) of FIG. 5 may further include a ground electrode (not shown) between the first insulation layers 470, 470-1, and 470-2 and either the substrate 300 or the display module 200. Here, the sensor sheet 440 may further include an additional insulation layer (not shown) between the ground electrode (not shown) and either the substrate 300 or the display module 200.

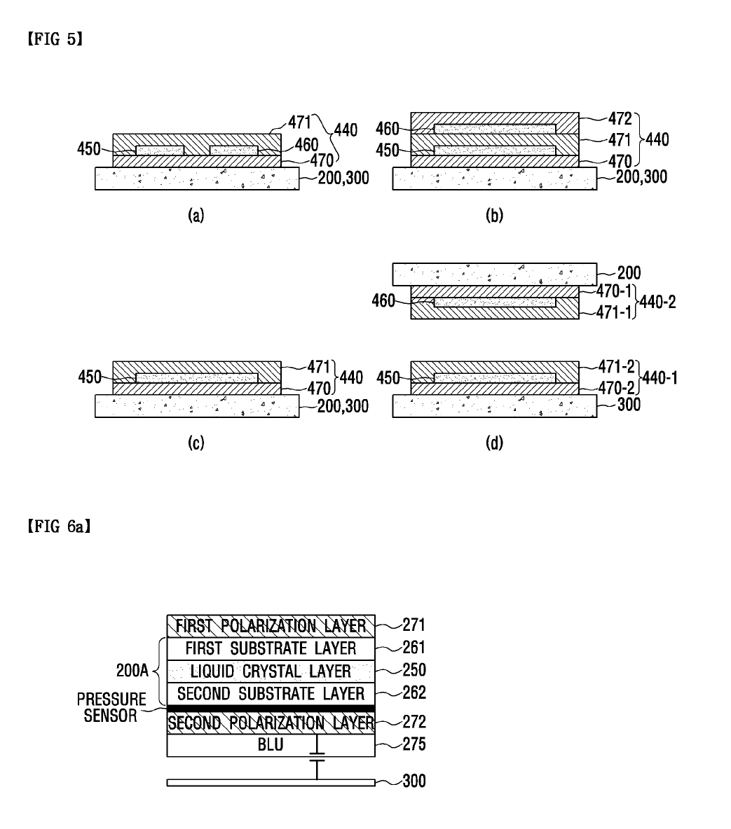

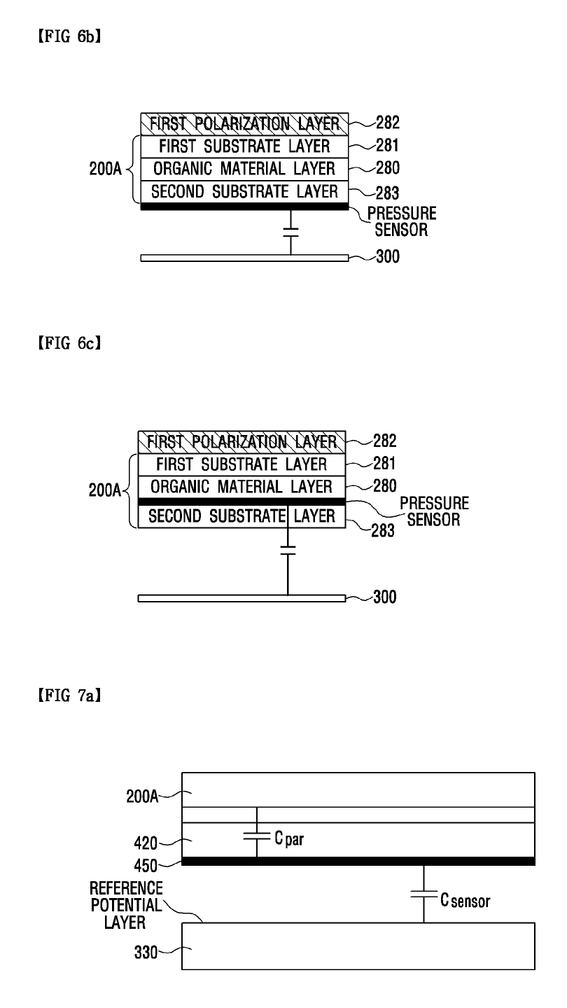

In the touch input device 1000 according to the embodiment of the present invention, the pressure sensors 450 and 460 may be directly formed on the display panel 200A. FIGS. 6a to 6c are cross sectional views showing an embodiment of the pressure sensor formed directly on various display panel of the touch input device according to the embodiment of the present invention.

First, FIG. 6a shows the pressure sensors 450 and 460 formed on the display panel 200A using the LCD panel. Specifically, as shown in FIG. 6a, the pressure sensors 450 and 460 may be formed on the bottom surface of the second substrate layer 262. Here, the pressure sensors 450 and 460 may be formed on the bottom surface of the second polarization layer 272. In detecting the touch pressure on the basis of the mutual capacitance change amount when a pressure is applied to the touch input device 1000, a drive signal is applied to the drive sensor 450, and an electrical signal including information on the capacitance which is changed by the distance change between the pressure sensors 450 and 460 and the reference potential layer separated from the pressure sensors 450 and 460 is received from the receiving sensor 460.

When the touch pressure is detected on the basis of the self-capacitance change amount, a drive signal is applied to the pressure sensors 450 and 460, and an electrical signal including information on the capacitance which is changed by the distance change between the pressure sensors 450 and 460 and the reference potential layer separated from the pressure sensors 450 and 460 is received from the pressure sensors 450 and 460. Here, the reference potential layer may be the substrate 300 or may be the cover which is disposed between the display panel 200A and the substrate 300 and performs a function of protecting the display panel 200A.

Next, FIG. 6b shows the pressure sensors 450 and 460 formed on the bottom surface of the display panel 200A using the OLED panel (in particular, AM-OLED panel). Specifically, the pressure sensors 450 and 460 may be formed on the bottom surface of the second substrate layer 283. Here, a method for detecting the pressure is the same as that described in FIG. 6a.

In the case of the OLED panel, since the organic material layer 280 emits light, the pressure sensors 450 and 460 which are formed on the bottom surface of the second substrate layer 283 disposed under the organic material layer 280 may be made of an opaque material. However, in this case, a pattern of the pressure sensors 450 and 460 formed on the bottom surface of the display panel 200A may be shown to the user. Therefore, for the purpose of directly forming the pressure sensors 450 and 460 on the bottom surface of the second substrate layer 283, a light shielding layer like black ink is applied on the bottom surface of the second substrate layer 283, and then the pressure sensors 450 and 460 may be formed on the light shielding layer.

Also, FIG. 6b shows that the pressure sensors 450 and 460 are formed on the bottom surface of the second substrate layer 283. However, a third substrate layer (not shown) may be disposed under the second substrate layer 283, and the pressure sensors 450 and 460 may be formed on the bottom surface of the third substrate layer. In particular, when the display panel 200A is a flexible OLED panel, the third substrate layer which is not relatively easily bent may be disposed under the second substrate layer 283 because the display panel 200A composed of the first substrate layer 281, the organic material layer 280, and the second substrate layer 283 is very thin and easily bent.

Next, FIG. 6c shows the pressure sensors 450 and 460 formed inside the display panel 200A using the OLED panel. Specifically, the pressure sensors 450 and 460 may be formed on the top surface of the second substrate layer 283. Here, a method for detecting the pressure is the same as that described in FIG. 6a.

Also, although the display panel 200A using the OLED panel has been described by taking an example thereof with reference to FIG. 6c, it is possible that the pressure sensors 450 and 460 are formed on the top surface of the second substrate layer 262 of the display panel 200A using the LCD panel.

Also, although it has been described in FIGS. 6a to 6c that the pressure sensors 450 and 460 are formed on the top surfaces or bottom surfaces of the second substrate layers 262 and 283, it is possible that the pressure sensors 450 and 460 are formed on the top surfaces or bottom surfaces of the first substrate layers 261 and 281.

Also, it has been described in FIGS. 6a to 6c that the pressure sensing unit including the pressure sensors 450 and 460 is directly formed on the display panel 200A. However, the pressure sensing unit may be directly formed on the substrate 300, and the potential layer may be the display panel 200A or may be the cover which is disposed between the display panel 200A and the substrate 300 and performs a function of protecting the display panel 200A.

Also, although it has been described in FIGS. 6a to 6c that the reference potential layer is disposed under the pressure sensing unit, the reference potential layer may be disposed within the display panel 200A. Specifically, the reference potential layer may be disposed on the top surface or bottom surface of the first substrate layers 261 and 281 of the display panel 200A or may be disposed on the top surface or bottom surface of the second substrate layers 262 and 283.

In the touch input device 1000 according to the embodiment of the present invention, the pressure sensors 450 and 460 for sensing the capacitance change amount may be, as described in FIG. 4g, composed of the first sensor 450 which is directly formed on the display panel 200A and the second sensor 460 which is configured in the form of a sensor sheet. Specifically, the first sensor 450 may be, as described in FIGS. 6a to 6c, directly formed on the display panel 200A, and second sensor 460 may be, as described in FIG. 4g, configured in the form of a sensor sheet and may be attached to the touch input device 1000.

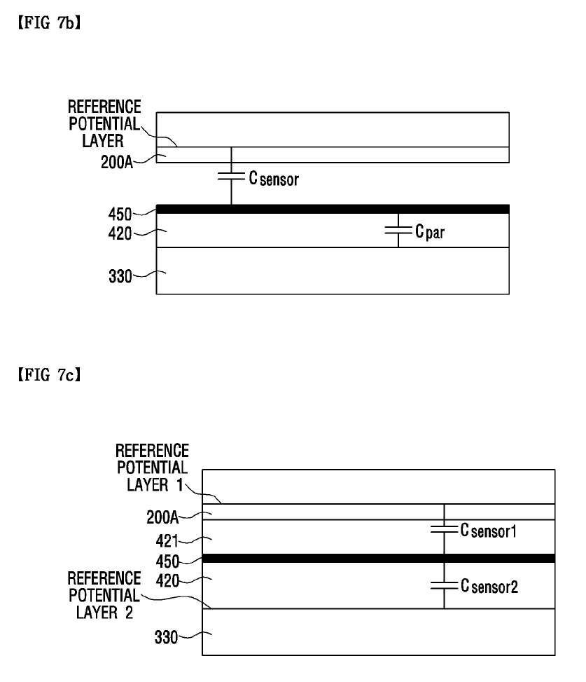

FIGS. 7a to 7c are cross sectional views illustratively showing the parasitic capacitance value in the touch input device according to the embodiment of the present invention.

Referring to FIG. 7a, when the reference potential layer is located at another place, instead of at the display panel 200A, the parasitic capacitance value Cpar can be calculating by floating the reference potential layer.

In FIG. 7a, for example, in order to calculate the capacitance value Csensor to be detected, when the reference potential layer is located in the frame 330, the parasitic capacitance value Cpar caused by external factors instead of the parasitic capacitance value Cpar between the pressure sensor 450 and the reference potential layer is calculated and is removed from the actually measured capacitance value, so that the capacitance value Csensor can be calculated.

There occurs an error between the capacitance value C sensor intended to be actually detected and the capacitance value obtained by using a conventional method for calculating the capacitance value. The embodiment of the present invention can be applied to solve the problem. That is to say, the actual value of the parasitic capacitance value Cpar can be obtained through the measurement by the floating of the reference potential layer, and an error caused by physical variation can be reduced.

For the purpose of floating the reference potential layer, a switching element that is electrically connected to the reference potential layer may be included. If the switching element is in an off-state, it can be determined that the reference potential layer is floating.

Also, before the display panel 200A and the frame 330 are assembled after being manufactured respectively, the capacitance value can be measured with respect to the display panel 200A. After the display panel 200A and the frame 330 are assembled, the thus measured capacitance value serves as the parasitic capacitance value Cpar caused by external factors instead of the parasitic capacitance value Cpar between the pressure sensor 450 and the reference potential layer. The parasitic capacitance value Cpar measured in advance before the display panel 200A and the frame 330 are assembled, may be stored in the memory and used to calculate the capacitance value Csensor intended to be actually detected.

In FIG. 7b, for example, in order to calculate the capacitance value Csensor to be detected, when the reference potential layer is located within the display panel 200A, the parasitic capacitance value Cpar caused by external factors instead of the parasitic capacitance value Cpar between the pressure sensor 450 and the reference potential layer is calculated and is removed from the actually measured capacitance value, so that the capacitance value Csensor can be calculated.

In this case, only the parasitic capacitance value Cpar can be calculated by floating the display electrodes (e.g., ELVSS, ELVDD, GND, etc.) within the display panel 200A. This parasitic capacitance value Cpar is used to remove the parasitic capacitance value Cpar in a normal operation. As a result, the capacitance value Csensor to be detected is accurately calculated, so that the magnitude of the touch pressure can be accurately detected.

Also, before the display panel 200A and the frame 330 are assembled after being manufactured respectively, the capacitance value can be measured with respect to the frame 330. In this case, the pressure sensor 450 is located on the frame 330. Therefore, after the display panel 200A and the frame 330 are assembled, the capacitance value measured between the frame 330 and the pressure sensor 450 serves as the parasitic capacitance value Cpar caused by external factors instead of the parasitic capacitance value Cpar between the pressure sensor 450 and the reference potential layer. The parasitic capacitance value Cpar measured in advance before the display panel 200A and the frame 330 are assembled, may be stored in the memory and used to calculate the capacitance value Csensor intended to be actually detected.

In FIG. 7c, for example, in order to calculate the capacitance values Csensor1 and Csensor2 to be detected, when the reference potential layer is located within the display panel 200A and the frame 330, the parasitic capacitance value Cpar caused by external factors instead of the parasitic capacitance value Cpar between the pressure sensor 450 and the reference potential layer is calculated and is removed from the actually measured capacitance value, so that the capacitance values Csensor1 and Csensor2 can be calculated.

In this case, the magnitude of the touch pressure can be accurately detected by using the capacitance values Csensor1 and Csensor2.

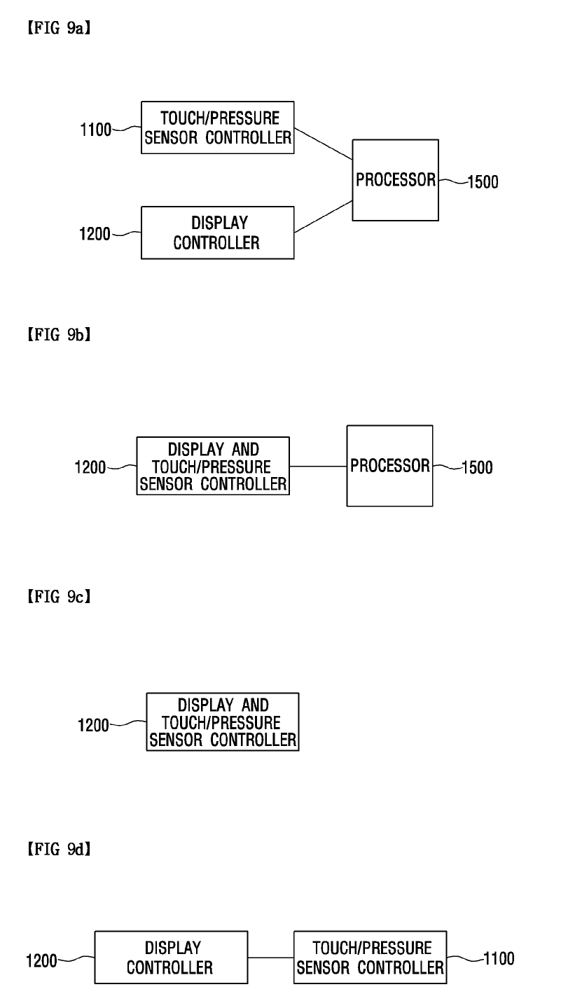

FIGS. 9a to 9d show various configuration of the control block included in the touch input device according to the embodiment of the present invention.

As shown in FIG. 9a, in the embodiment of the present invention, the pressure sensor controller 1300 may be integrated with the touch sensor controller 1100, and the display controller 1200 may be separately provided. Here, the host processor 1500 is separately provided, transmits a control signal to the touch/pressure sensor controller 1100 and the display controller 1200, and collects and processes information from the controllers 1100 and 1200.

The operation to calculate the parasitic capacitance value Cpar in the embodiment of the present invention may be performed by the touch/pressure sensor controller 1100 or the host processor 1500. The touch/pressure sensor controller 1100 may be, for example, a touch controller IC, and the host processor 1500 may be, for example, an application processor (AP).

As shown in FIG. 9a, in the embodiment of the present invention, the touch sensor controller 1100 and the pressure sensor controller 1300 are integrated with the display controller 1200 and may form one controller. Here, the host processor 1500 is separately provided, transmits a control signal to the display and touch/pressure sensor controller 1200, and collects and processes information from the controller 1200.

The operation to calculate the parasitic capacitance value Cpar in the embodiment of the present invention may be performed by the display and touch/pressure sensor controller 1200 or the host processor 1500. The display and touch/pressure sensor controller 1200 may be, for example, a touch controller IC, and the host processor 1500 may be, for example, an application processor (AP).

As shown in FIG. 9c, in the embodiment of the present invention, the touch sensor controller 1100 and the pressure sensor controller 1300 are integrated with the display controller 1200 and may form one controller. Here, the host processor 1500 is not separately provided. The display and touch/pressure sensor controller 1200 serves as the host processor. The display and touch/pressure sensor controller 1200 may directly generate a control signal and collect and process the obtained information.

The operation to calculate the parasitic capacitance value Cpar in the embodiment of the present invention may be directly performed by the display and touch/pressure sensor controller 1200. The display and touch/pressure sensor controller 1200 may be, for example, a touch controller IC.

As shown in FIG. 9d, in the embodiment of the present invention, the pressure sensor controller 1300 may be integrated with the touch sensor controller 1100, and the display controller 1200 may be separately provided. Here, the host processor 1500 is not separately provided. The display controller 1200 or the touch/pressure sensor controller 1100 serves as the host processor. The display controller 1200 or the touch/pressure sensor controller 1100 may directly generate a control signal and collect and process the information obtained from the opposite controller.

The operation to calculate the parasitic capacitance value Cpar in the embodiment of the present invention may be directly performed by the touch/pressure sensor controller 1100. The touch/pressure sensor controller 1100 may be, for example, a touch controller IC.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A touch input device comprising:
a display panel;
a pressure sensor which is disposed under the display panel;
a reference potential layer which is disposed apart from the pressure sensor; and
a controller which receives an output voltage from the pressure sensor and calculates a first capacitance value, and calculates a second capacitance value by removing a parasitic capacitance value from the first capacitance value,
wherein the controller receives the output voltage from the pressure sensor in a state where the reference potential layer is floating, and calculates the parasitic capacitance value.

2. The touch input device of claim 1, further comprising a switching element which is electrically connected to the reference potential layer, wherein the reference potential layer is floating when the switching element is in an off-state.

3. The touch input device of claim 1, wherein the first capacitance value is changed according to a distance change between the pressure sensor and the reference potential layer.

4. The touch input device of claim 1, wherein the reference potential layer is located within the display panel, and wherein the second capacitance value is a capacitance value between the pressure sensor and the reference potential layer.

5. The touch input device of claim 1, further comprising a frame disposed under and apart from the pressure sensor, wherein the reference potential layer is located in the frame, and wherein the second capacitance value is a capacitance value between the pressure sensor and the reference potential layer.

6. The touch input device of claim 1, further comprising a frame disposed under the pressure sensor, wherein the pressure sensor is disposed apart from the display panel and the frame.

7. The touch input device of claim 6, wherein the reference potential layer comprises a first reference potential layer and a second reference potential layer, and wherein the first reference potential layer is located within the display panel and the second reference potential layer is located in the frame.

8. The touch input device of claim 7, wherein the second capacitance value is calculated based on a capacitance value between the pressure sensor and the first reference potential layer and a capacitance value between the pressure sensor and the second reference potential layer.

9. The touch input device of claim 1, wherein the controller calculates the first capacitance value in a first time interval, and wherein the controller calculates the parasitic capacitance value in a second time interval different from the first time interval.

10. The touch input device of claim 9, wherein the controller periodically calculates the parasitic capacitance value.

11. The touch input device of claim 1, wherein the controller is a touch controller IC or an application processor (AP).

12. A touch input device comprising:
a display panel;
a pressure sensor which is disposed under the display panel; and
a controller which receives an output voltage from the pressure sensor and calculates a first capacitance value, and calculates a second capacitance value by removing a parasitic capacitance value from the first capacitance value,
wherein the controller receives the output voltage from the pressure sensor in a state where the display panel has been assembled, and calculates the parasitic capacitance value.

13. A method for measuring a capacitance of a touch input device, the method comprising:
completing a display panel and forming a pressure sensor on the display panel;
measuring a parasitic capacitance value of the display panel by using the pressure sensor; and
combining the display panel and a frame.

14. The method of claim 13, further comprising, after combining the display panel and the frame, measuring a third capacitance value through a pressure applied to the display panel by using the pressure sensor, and removing the parasitic capacitance value from the third capacitance value.

15. The method of claim 14, wherein the parasitic capacitance value is stored in a memory and used.

16. A method for measuring a capacitance of a touch input device, the method comprising:
completing a frame and forming a pressure sensor on the frame;
measuring a parasitic capacitance value of the frame by using the pressure sensor; and
combining the display panel and a frame.

17. The method of claim 16, further comprising, after combining the display panel and the frame, measuring a fourth capacitance value through a pressure applied to the display panel by using the pressure sensor, and removing the parasitic capacitance value from the third capacitance value.

18. The method of claim 17, wherein the parasitic capacitance value is stored in a memory and used.
